(19) United States
(12) Patent Application Publication
(10) Pub. No.: US 2017/0208255 A1
(43) Pub. Date: Jul. 20, 2017

(54) SYSTEM FOR ASSESSING THE VISUAL APPEARANCE OF A REFLECTIVE SURFACE

(71) Applicant: Rhopoint Instruments Ltd., GREAT BRITAIN (GB)

(72) Inventors: Klaus CHRISTEN, Sassenburg (DE); Dirk WEISSBERG, Burgwedel (DE); Klaus ROTHS, Ahaus (DE); Anthony David BURROWS, Otford (GB); Pierre MORANDI, East Sussex (GB); Thomas DAUSER, Eichstätt (DE)

(73) Assignee: Rhopoint Instruments Ltd., GREAT BRITAIN (GB)

(21) Appl. No.: 15/403,828

(22) Filed: Jan. 11, 2017

(30) Foreign Application Priority Data
Jan. 14, 2016 (EP) 16151243.9

(51) Int. Cl. H04N 5/232; G06T 7/90

(52) U.S. Cl. CPC H04N 5/23293; G06T 7/90

(57) ABSTRACT

The invention refers to a system for assessing the visual appearance of a reflective surface. The system comprises a visual capturing device, adapted to capture at least one image focusing the reflective surface and at least one complementary image focusing a reflection of a test image reflected from the reflective surface. The system further comprises a data processing unit, capable of assessing visual appearance of the reflective surface by deriving objective quality parameters from the one image and the complementary image and by comparing the objective quality parameters with data of a database. The invention further refers to a method of assessing the visual appearance of a reflective surface using the system.

The invention refers to a system for assessing the visual appearance of a reflective surface and a method of assessing the visual appearance of a reflective surface, wherein the system is used.

Reflective surfaces are comprised by a variety of products, such as furniture, white goods, electronics or vehicles. Assuring the quality of such reflective surfaces is an important matter in the respective industries in order to meet customer requirements.

### STATE OF THE ART

It is well known in the art to apply measurement techniques in order to detect certain objective quality parameters of a reflective surface. Some examples are waviness, roughness, color intensity or the distinctness of image (DOI) once an image is reflected by the reflective surface. These and other objective quality parameters can be derived from measurement data. Just as an example, a color intensity of a reflective surface can be detected by a photo sensor sensitive to a certain wavelength. Here, light reflected by the reflective surface reaching the photo sensor can be turned into a voltage signal representing the wavelength. The objective quality parameter can then be expressed as a certain intensity level of the voltage signal regarding this wavelength.

From the technical point of view, objective quality parameters are proper to fully determine the quality of a reflective surface. Therefore they are highly applicable to assure a certain quality standard throughout the entire production of a number of reflected surfaces, for example in series production.

DE 10 2008 038 256 A1 discloses a device for optical inspection of a surface of an automobile. A pattern is displayed by an LCD-display and reflected by the surface of the automobile. The reflected patterns are detected by a camera and processed by a control and processing unit. From the processed data objective quality parameters of the surface are derived, such as waviness.

In DE 102 91 985 B4 a method of examining a surface structure is objected. A housing, comprising a number of light sources, is used to illuminate a segment of the surface structure successively from different relative positions. Different pictures are captured by a camera. Thus, independent data sets are created. Information about the surface structure is gained from these independent data sets. Failure effects influencing the pictures are then reduced by combining information from the independent data sets.

In U.S. Pat. No. 5,142,648 A another method of inspecting a painted surface is disclosed. The method is based on the processing of camera images, determining the modulation transfer function and quantifying the DOI.

U.S. Pat. No. 5,589,904 A discloses a camera system that detects motion of the system and accomplishes a compensation movement so as to securely take a number of pictures in a sequence.

An article by Daniela Florian et.al: “Implementation of real time auto focus methods for static and dynamic infrared imaging of power semi conductor chips”, published on the 11^{th} International Conference on Quantitative InfraRed Thermography “QIRT” in 2012, further describes the implementation of real time auto focusing methods in to be applied in quality inspection of semiconductor chips.

Another article by Andor et.al: “CCD Spatial Resolution”; that is accessible online via http://www.andor.com/learning-academy/ccd-spatial-resolution-understanding-spatial-resolution (last access on Dec. 28, 2016), deals with influencing factors on the spatial resolution of CCD cameras.

Still another article by Stefan Werling et.al: “Metrology and Measurement Systems Inspection of specular and partially specular surfaces”, published by the Polish Academy of Sciences in 2009, discusses the theoretical background of optical deflectometry.

US 2014/043602 A1 describes a system for optical inspection of items, wherein the system is adapted to inspect the item from different distances.

Additionally, several devices to measure the gloss of a surface are known in the art, such as the product “NOVO-GLOSS” developed by the applicant.

U.S. Pat. No. 4,846,578 A describes a method of measuring surface characteristics. The characteristics measured can for example be the degree of distortion and the degree of blurring.

Finally, U.S. Pat. No. 5,155,558 A describes a method and an apparatus for analyzing the appearance features of a surface. The document teaches taking a picture while focusing the surface and taking another picture while focusing a test image. Then, from the taken images the selected surface parameters are derived.

A further approach of determining the quality of reflective surfaces refers to assess visual appearance of the reflective surface. The term visual appearance, in contrast to the term objective quality parameters, refers to the subjective human perception of the reflective surface. Subjectivity implies that there is no objective parameter suitable to describe the visual appearance. That is why it has been practiced in the art to assess the visual appearance by manual visual inspection.

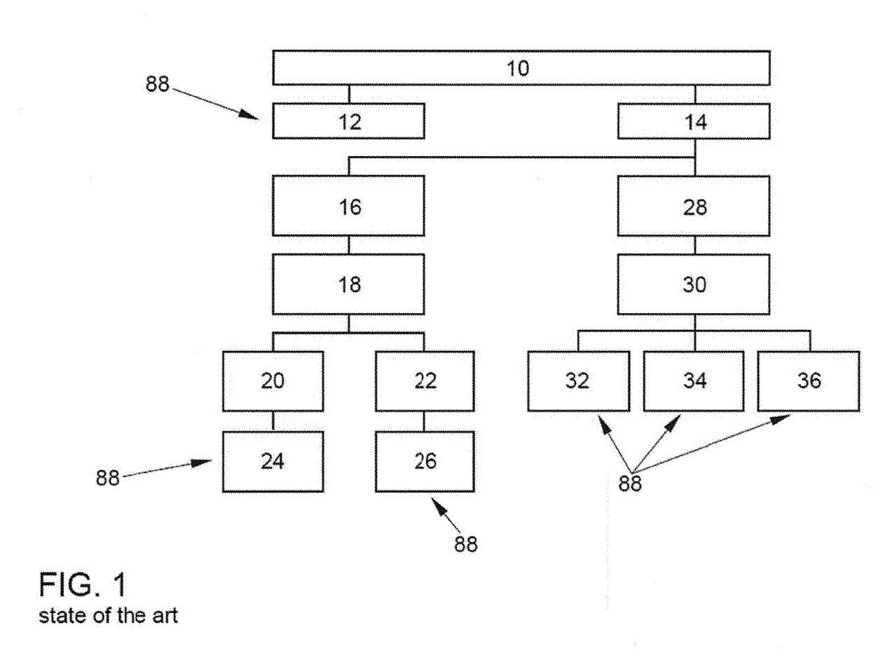

It is known in the art that some correlation between objective quality parameters of an item and visual appearance of the item exists. In other words, some objective quality parameters, such as waviness, are known as influencing factors on the visual appearance of the item to a human being. However, this correlation differs from one human being to the other. Therefore, the correlation is only a qualitative correlation. An overview of the objective quality parameters acting as influencing factors on the visual appearance of an item is illustrated in FIG. 1.

### DISCLOSURE OF THE INVENTION

It is an objective of the invention to develop a technical system that is capable of automatically assessing the visual appearance of a reflective surface in an easy, fast and flexible manner.

The invention refers to a system for assessing the visual appearance of a reflective surface, comprising at least:

a) a visual output device, adapted to display at least one test image onto the reflective surface;

b) a visual capturing device, comprising an adjustable focal point position;

wherein the adjustable focal point position is tunable to the reflective surface as one capturing position and to a complementary capturing position that allows for clear capturing of the test image as a reflection from the reflective surface; and

wherein the visual capturing device is adapted to capture at least one image in the one capturing position and to capture at least one complementary image in the complementary capturing position;

c) a data processing unit, comprising a database and an evaluation algorithm;

wherein the database is equipped with data representing correlation between visual appearance of reflective reference surfaces and objective quality parameters; and

wherein the evaluation algorithm is adapted to derive the objective quality parameters of the reflective surface from the one image and from the complementary image and to compare the objective quality parameters with the data of the database to assess visual appearance of the reflective surface.

The test image or the test images are preferably fringe patterns, blocks, lines, circles or other test images known in the art that are applicable to analyze certain objective quality parameters of a reflective surface. Displaying such test images onto the reflective surface and capturing an image of the reflective surface including a reflection of the test image allows for deriving a number of objective quality parameters from the captured image. These objective quality parameters include unevenness in different orders of magnitude, such as sharpness, roughness, contrast, global waviness, waviness in a shortwave range and waviness in a longwave range. Further derivable objective quality parameters are a specular gloss, haze or DOI of the test image as the reflection from the reflective surface. In general, all these objective quality parameters can be analyzed in different orders of magnitude and are mentioned in FIG. 1. To a person skilled in the art it is well known how to measure the objective quality parameters mentioned by means of picture capturing.

The system comprises all technical means necessary to capture the one image in the one capturing position and to capture the complementary image in the complementary capturing position so that the one image and the complementary image as a combination embody all information required to derive at least those objective quality parameters shown in FIG. 1. This means that the information embodied by the complementary image is complementary to the information embodied by the one image regarding these objective quality parameters of an identic area of the reflective surface. On the one hand this implies that in the one capturing position the adjustable focal point position needs to be tuned onto the reflective surface. In case of a non-planar surface the adjustable focal point position is tuned on a plane representing the reflective surface which is a well known procedure in measurement engineering. On the other hand this implies that in the complementary capturing position the adjustable focal point position needs to be tuned so as to allow for clear capturing of the test image as a reflection from the reflective surface. In other word the adjustable focal point position needs to be tuned on the test image in the complementary focal point position. A distance from the visual capturing device to its adjustable focal point position tuned to the complementary capturing position is equivalent to a distance from the visual capturing device to the reflective surface in addition to a distance from the reflective surface to the visual output device. The term clear capturing of the test image means that the adjustable focal point position is tuned in way so that the test image appears as sharp as possible. This state indicates that the adjustable focal point position is correctly tuned to the complementary capturing position.

It is important to the system of the invention that the visual capturing device is adapted to capture at least the one image and the complementary image as stated above. It is further important to the system of the invention that the evaluation algorithm is adapted to derive the objective quality parameters from the one image and the complementary image shown in FIG. 1. Preferably, objective quality parameters are derived that occur at certain orders of magnitude of a wavelength. In other words, each objective quality parameter is detectable or derivable at a wavelength of a certain order of magnitude, which means power of ten (10^{x}). The order of magnitude of this wavelength preferably ranges from 10⁻³ mm to 10¹ mm, depending on the objective quality parameter to be derived from the respective image. Just as an example, gloss effects can be detected at a wavelength of 0.002 mm. Just as another example, orange peel effects can be detected at a wavelength of 30 mm. Preferably a variety of orders of magnitude of a wavelength is analyzed. This advantageously allows for making all objective quality parameters detectable that are relevant for the assessment of the visual appearance of a certain reflective surface. Preferably 2 to 15 orders of magnitude of a wavelength are analyzed, further preferred 4 to 13, further preferred 6 to 12, further preferred 8 to 11 and further preferred 9 to 10.

It is further important to the system of the invention that the database is equipped with data representing correlation between visual appearance of reflective reference surfaces and objective quality parameters. Therefore the data comprise empirically investigated correlation of the average human perception of a variety of reflective reference surfaces comprising determined objective quality parameters. The device of the invention is therefore capable of assessing the visual appearance of a given reflective surface by determining the objective quality parameters and comparing them with the data. Once again, emphasis shall be given to the fact that the visiual appearance, assessed by the device of the invention, is not limited to objective quality parameters, such as gloss or waviness. The result delivered by the device of the invention is a summary of the sensation an person would experience when looking at the reflective surface that is tested with the device. Here, just as an example, the result delivered by the device of the inventiojn could be “good”, “average” or “bad” as well as “dirty” or “precious” or the like. In other words the device of the invention assesses the visual appearance of the reflective surface by measuring a number of objective quality parameters and translating these parameters into the subjective human sensation of a specific target group, for example customer group, whose sensation in correlation to the obejective quality parameters is stored in the data.

It is an advantage of the device of the invention that the device is capable of automatically assessing the visual appearance of a given reflective surface. Compared to conventional manual visual assessment this advantageously increases the of the assessment due to the implemented information about the average human perception of reflected reference surfaces. The term accuracy refers to validity of the assessment in real life as well as reproducibility. In case of the manual visual assessment the visual appearance is always determined by the opinion of a single person. Furthermore the device of the invention advantageously decreases the effort for the assessment of visual appearance. Another advantage is that more reflective surfaces can be assessed in the same time. Assessment of the visual appearance by the system of the invention is much faster than by manual visual inspection. It is advantageously not necessary to move the system across the reflective surface as all objective quality parameters are derived from images. The system of the invention is also highly flexible as its ability of assessing the visual appearance of different reflective surface is scalable by adapting the data stored in the database.

In a preferred embodiment of the system of the invention the data of the database comprise logical conjunction of:

statistically confirmed results of target group interrogation regarding visual appearance of reflective reference surfaces; and

objective quality parameters.

Group interrogation is known in the field of human behavioral studies. Research has revealed that proper data regarding the correlation between visual appearance of reflective reference surfaces and objective quality parameters can be gained by transferring this method to measurement engineering. Correlation between visual appearance of reflective reference surfaces and objective quality parameters can be revealed the following steps: First, a number of reflective reference surfaces comprising the entire spectrum of characteristics of objective quality parameters that may occur in a certain field, for example automotive skin panel parts, is manufactured. Then, a number of test people representing a certain customer target group can is chosen. For example, a customer target group can represent an average consumer, a business customer or a proficient customer. The reflective reference surfaces are then assessed by each one of the test people of a customer target group regarding its visual appearance. The results of this manual visual assessment is then logically interlinked with the known manufactured characteristics of the objective quality parameters. As a result, a certain combination of quantified characteristics of one or more objective quality parameters leads to a certain visual appearance as it is, at an average, sensed by the target group. The number of test people is chosen accordingly, as to assure statistic validity of the results.

This advantageously increased the accuracy and flexibility of the system of the invention. The possibility of adjusting the assessment of visual appearance executed by the system of the invention to a specific customer target group is one more striking advantage.

In a preferred embodiment of the system of the invention the data processing unit comprises a control algorithm adapted to automatically control the steps of:

a) displaying the at least one test image;

b) tuning the adjustable focal point position to the one capturing position;

c) capturing at least one image in the one capturing position;

d) tuning the adjustable focal point position to the complementary capturing position;

e) capturing at least one complementary image in the complementary capturing position;

f) deriving objective quality parameters of the reflective surface from the one image and from the complementary image;

g) comparing the objective quality parameters with the data of the database to assess visual appearance of the reflective surface; and

h) outputting a result representative for visual appearance of the reflective surface.

The sequence of the steps a) to f) is not limited to the sequence stated above. All sequences that are technically reasonable in order to come to step g) and finally h) are concerned by the invention.

This embodiment of the system of the invention advantageously increases the speed of assessing the visual appearance.

Preferably, the control algorithm is adapted to:

repeat the steps a) to g) using different test images; and

combining results of all iterations of step g); and

outputting a result representative for visual appearance of the reflective surface.

Here, it is an advantage of the system of the invention that the accuracy of the assessment is significantly increased. For example, it is possible to compensate for measurement mistakes by the use of different test images. Furthermore, the use of different test images allows for adaption of the test images to the given reflective surface. An advantage of the system is that the possibility of using different test images allows the use of known optical test methods such as optical transfer function, point spread function, line spread function and image analysis associated with defect detection and image distortion.

In a preferred embodiment of the system of the invention the system comprises a contact section adapted to position the system on the reflective surface.

This advantageously allows for easy and accurate positioning of the system relative to the reflective surface to be assessed. Especially a distance between the system and the reflective surface can be kept at a constant state this way. Furthermore, vibrations from the environment can be eliminated. All this increases the accuracy of the assessment.

In a preferred embodiment of the system of the invention the visual capturing device comprises a mechanism, adapted to automatically tune the adjustable focal point position. Preferably the visual capturing device comprises a lens system with an actuator to adjust the relative position of the lenses.

This advantageously makes the tuning of the adjustable focal point position accurate, fast and easy.

For example, the lens system may comprise one ore more lenses with each lens comprising individual optical properties. In the art, lenses with various optical properties are well known. It is further known in the art to design lens systems with adapted optical properties. Regarding the system of the invention it is, for example, possible to use one or more lenses comprising a fixed focal length. The adjustable focal position of the visual capturing device may then, just as an example, be tuned by moving the visual capturing device itself. Another example is to use one or more lenses with an additional collimation functionality. This allows for tuning the adjustable focal position of the visual capturing device by adjusting the relative position of the lenses. All this allows to measure objective quality parameters required for the assessment of the visual appearance of a variety of reflective surfaces. Furthermore one or more lenses with a variable focal length can be used. Such lenses are well known in the art. Here, fluid lenses are only one example. In this case, the investigated reflective surface can be analyzed at different levels of magnification and consequently different levels of spatial resolution. As an example, a higher spatial resolution allows for detecting the reflective surface or a reflection coming from the reflective surface at a higher level of details. A lower spatial resolution allows for detecting the reflective surface or a reflection coming from the reflective surface at a lower level of details. This way, the spatial resolution can advantageously be adapted with regard to the specific objective quality parameters to be measured.

In a preferred embodiment of the system of the invention the visual capturing device is adapted to allow for capturing of the one image in the one capturing position and the complementary image in the complementary capturing position so that an area of the reflective surface covered by (each) the one image and the complementary image measures at least 20 mm by 10 mm, preferably at least 22.5 mm by 13 mm, even more preferably 25.3 mm by 16.1 mm and further preferred up to 30 mm by 20 mm.

This advantageously assures that the area of the reflective surface that is captured in the one image and in the complementary image comprises all visual surface effects sensible by a human being from a distance to the reflective surface of 0.1 m to 3 m. This is the range that is commonly relevant for a human being visually assessing the quality of a reflective surface. If a smaller area of the reflective surface is covered not all of the relevant effects are comprised by this area. If a larger area of the reflective surface is covered the effort of assuring a sufficient resolution will grow too high, taking state-of-the-art means of picture capturing into account.

In a preferred embodiment of the system of the invention the visual capturing device is adapted to tune the adjustable focal point position with an accuracy of at least +/−0.3 mm, further preferred at least +/−0.2 mm, even more preferred at least +/−0.1 mm and further preferred at least +/−0.01 mm. The term at least means that a better accuracy is always desired and only limited by the available technical means. It is trivial to say that an accuracy of +/−0 mm, which would be an optimum, is not technically possible.

Research has revealed that the minimum accuracy mentioned above is sufficient for generating assessment results of reflective surfaces that meet the requirements in many industries, such as the automotive industry.

In a preferred embodiment of the system of the invention the adjustable focal point position is tunable in less than 500 ms, preferably less than 400 ms and even more preferably less than 300 ms. It is trivial to say that a tuning time of 0 ms, which would be an optimum, is not technically possible. Still, it is desirable to reduce this time as far as possible to reduce the time necessary for assessment of the visual appearance.

Mostly preferred the adjustable focal point position is tunable in less 300 ms. This advantageously allows for fast assessment of visual appearance that meets the requirements of real time assessment in combination with acceptable technical effort.

In a preferred embodiment of the system of the invention the visual capturing device comprises an image sensor comprising a pixel size of less than 50 μm, preferably less than 30 μm, further preferred less than 20 μm and even more preferred less than 10 μm. It is trivial to say that a pixel size of 0 μm, is not technically possible, nor is it technically reasonable a no sensitive surface of the sensor would be left to capture an image. Still, it is desirable to reduce the pixel size as far as possible in order to increase the resolution of the images.

In a preferred embodiment of the system of the invention the system is a hand-held unit.

This leads to a number of significant advantages. One advantage is that the flexibility is increased as the hand-held unit is easily portable. Therefore it is applicable in many stages of a production process and for interims, final or even after-sales inspection. Another advantage is that the hand-held unit, as it is held and operated by a human, simulates the perspective of the operating human.

Preferably, dimensions of the system measure not more than 200 mm by 150 mm by 60 mm and/or a weight of the system measures not more than 1.5 kg and/or the system comprises an energy source. It is trivial to say that minimum dimensions and weights of the system depend on the existing technical means and on ergonomic requirements.

Research has revealed that maximum dimensions and the maximum weight as stated above meet ergonomic requirements of most operators.

In a preferred embodiment of the system of the invention the system comprises at least one of the following elements:

a display as a feature of the visual output device;

a camera as a feature of the visual capturing device;

a microprocessor as a feature of the data processing unit;

a graphical user interface;

means of wireless communication.

The display of the visual output device preferably is an LCD display featuring a high brightness to advantageously reduce the acquisition time. The camera preferably is a state-of-the-art machine vision camera with a custom variable focus lens. These cameras are well know in the field of automation engineering. The data processing unit preferably is an industrial micro computer. It preferably comprises state-of-the-art interfaces, such as USB & Ethernet. External data storage is preferably by micro SD or USB data devices. The graphical user interface preferably comprises another display, preferably an LCD display and an input device, preferably a capacitive keypad. The means of communication preferably comprise state-of-the-art interfaces, such as USB, Bluetooth, QI code reader, QR code reader, RFID reader and other interfaces known in the art.

For example, once a reflective surface is assessed, an identification number of the reflective surface can be detected by an RFID reader of the system of the invention. A result of the assessment can then be transmitted to an external system, for example via WLAN.

The invention further refers to a method of assessing the visual appearance of a reflective surface of a vehicle, wherein a system according to one of the preceding claims is used.

The method of the invention allows for fast, easy, flexible and accurate assessment of the visual appearance of the reflective surface of a vehicle. For example, the vehicle can be a car and the reflective surface can be a skin panel part of the car.

All advantages of the method of the invention are based on the advantages of the system of the invention as described above.

The definition of the terms regarding the system of the invention as stated above are valid for the method of the invention, as well.

In a preferred embodiment of the method of the invention the method comprises at least the step of:

a) positioning of a contact section of the system on the reflective surface of the vehicle;

b) displaying of at least one test image onto the reflective surface by a visual output device of the system;

c) tuning of an adjustable focal point position of a visual capturing device of the system to the reflective surface as one capturing position;

d) capturing of at least one image in the one capturing position by the visual capturing device;

e) tuning of the adjustable focal point position to a complementary capturing position that allows for clear capturing of the test image as a reflection from the reflective surface;

f) capturing of at least one complementary image in the complementary capturing position;

g) deriving of objective quality parameters of the reflective surface from the one image and from the complementary image by an evaluation algorithm of a data processing unit; and

h) comparing of the objective quality parameters with data of a database of the a data processing unit representing correlation between visual appearance of reflective reference surfaces and the objective quality parameters by the evaluation algorithm to assess visual appearance of the reflective surface.

Further preferred embodiments of the system of the invention and of the method of the invention are described in the depending claims.

The different embodiments of the system and of the method of the invention disclosed in this application can advantageously be combined as long as nothing is said regarding the contrary.

The invention is further described by the following embodiments in combination with the Figures referring to the respective embodiment.

The Figures illustrate the following:

FIG. 1 shows an overview of objective quality parameters acting as influencing factors on the visual appearance of an item (state of the art);

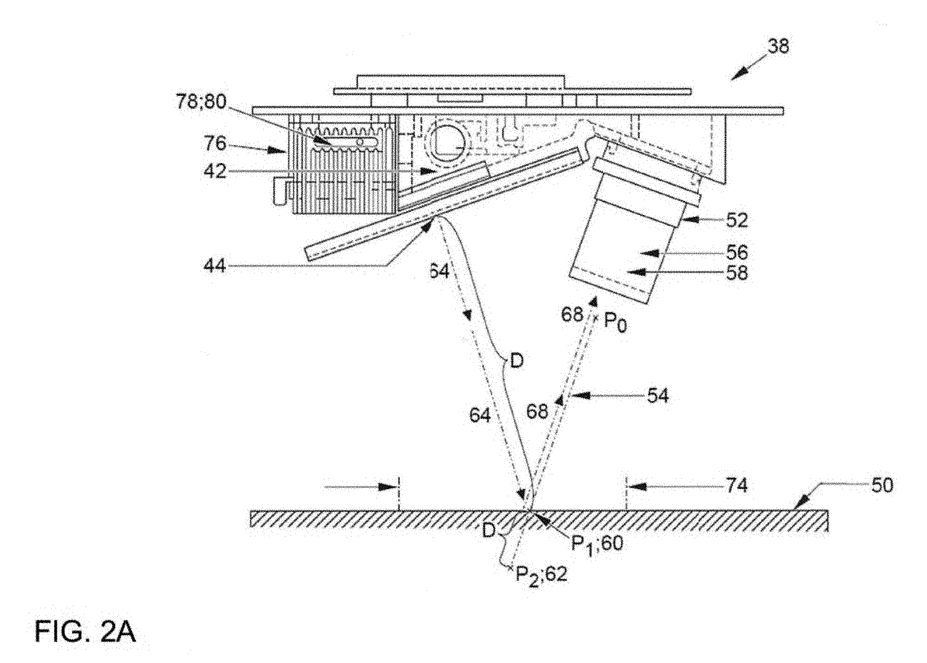

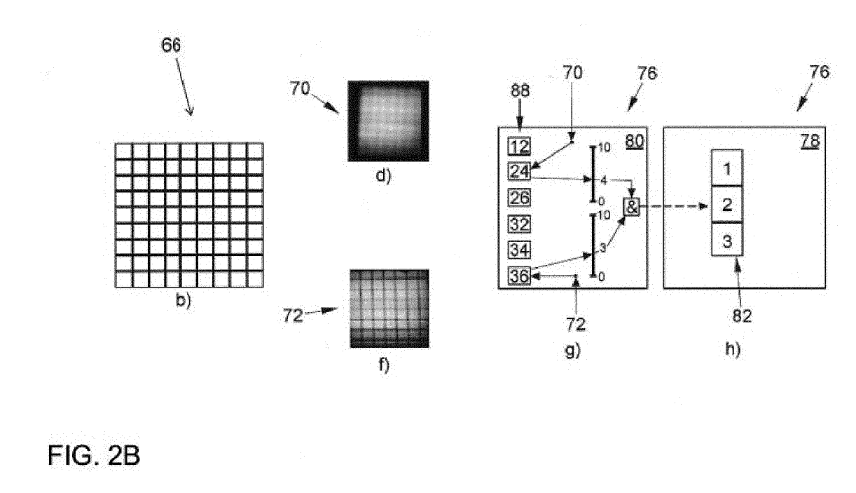

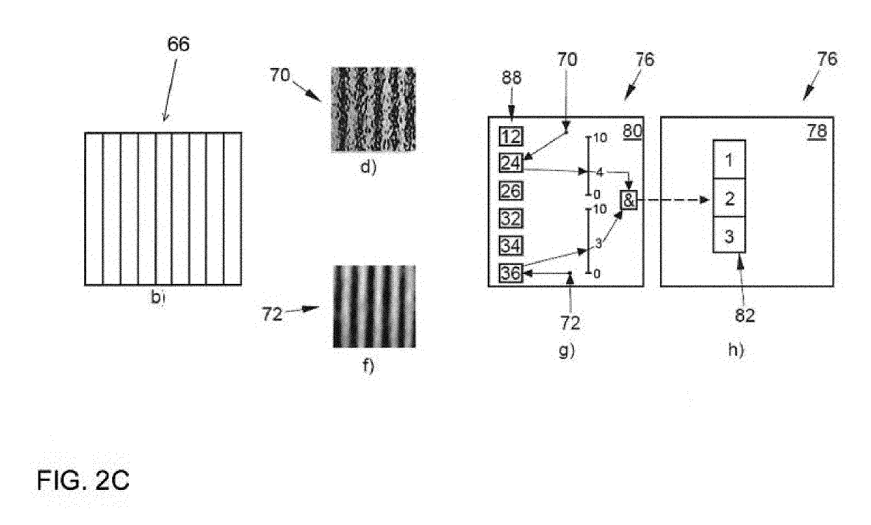

FIG. 2A shows a preferred embodiment of a system for assessing the visual appearance of a reflective surface according to the invention;

FIGS. 2B and 2C each show a preferred embodiment of a method of assessing the visual appearance of a reflective surface of a vehicle, wherein a system according to the invention is used; and

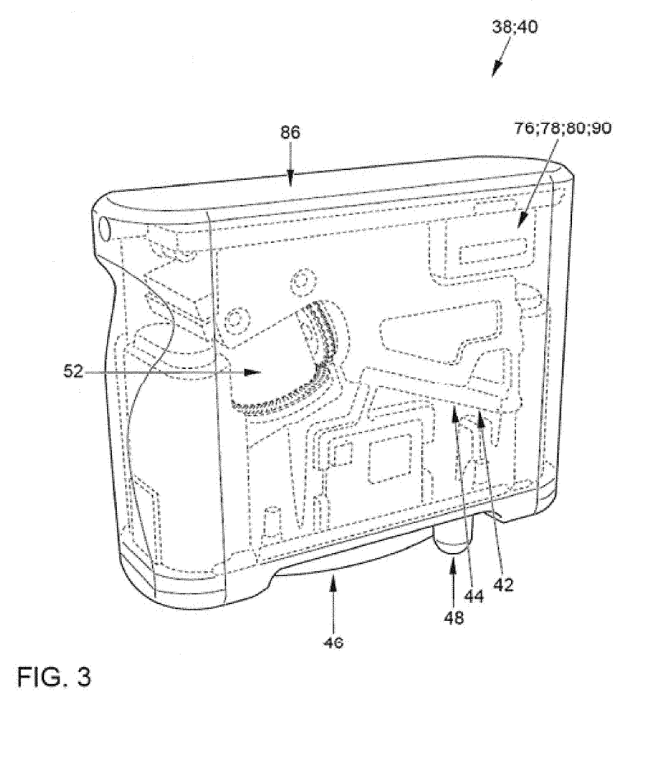

FIG. 3 shows preferred embodiment of a system for assessing the visual appearance of a reflective surface according to the invention.

FIG. 1 illustrates an overview of objective quality parameters acting as influencing factors on the visual appearance of an item according to state of the art. Visual appearance 10 is influenced by a color 12 as a first one of the objective quality parameters 88 and by a gloss 14 of the item. The gloss 14 of the item is influenced by a number of influencing factors that are observable by observing a surface of the item itself, which means focusing the surface of the item 16. These influencing factors are included in a waviness 18 of the surface of the item and are observable at different orders of magnitude of the wavelength. The major orders of magnitude are commonly referred to as longwave spectrum 20 and shortwave spectrum 22. The longwave spectrum 20 reveals a second one of the objective quality parameters 88 commonly referred to in the art as orange peel 24. The shortwave spectrum 22 reveals a third one of the objective quality parameters 88 commonly referred to in the art as a microwaviness 26. The gloss 14 of the item is further influenced by influencing factors that are detectable by observing an image that is reflected by the surface of the item. This means focusing a reflection of the image 28. Here, the DOI 30 of the image can be determined. It incorporates three more objective quality parameters 88 which are commonly referred to in the art as specular gloss 32, haze 34 and clarity 36 of the reflected image.

FIG. 2 illustrates a preferred embodiment of a system for assessing the visual appearance of a reflective surface according to the invention along with a preferred embodiment of a method of assessing the visual appearance of a reflective surface of a vehicle, wherein a system according to the invention is used.

For reasons of clarity, the content of FIG. 2 is allocated to FIGS. 2A, 2B and 2C.

FIG. 2A primarily emphasizes aspects of the design of the system, FIGS. 2B and 2C primarily emphasize aspects of the method. However, FIG. 2A, needs to be considered as a unit with FIGS. 2B and 2C illustrating alternatives regarding test images 64 displayed onto the reflective surface 50, represented by an alternative single test image 66 that is illustrated in FIGS. 2B and 2C.

In the preferred embodiment of the system 38 shown in FIG. 2A a visual output device 42 is shown. The visual output device 42 comprises a display 44. The visual output device 42 is adapted to display a variety of different test images 64. The display 44 is a high brightness LCD screen in this embodiment. As further shown in FIG. 2A, the visual output device 42 is adapted to display the test images 64 onto the reflective surface 50. Displaying the at least one test image 66 onto the reflective surface 50 by the visual output device 42 matches step b) of the method of the invention. Just as an example, the one test image 66, displayed onto the reflective surface in step b) of the method of the invention, is illustrated in FIGS. 2B and 2C with FIG. 2B showing the one test image 66 as a number of squares while FIG. 2C alternatively shows the one test image 66 as a number of lines.

The system 38 shown in FIG. 2A further comprises a visual capturing device 52. The visual capturing device 52 has an adjustable focal point position 54. The adjustable focal point position 54 is adjustable in a range from a point P₀ to P₂. P₀ marks a point closest to the visual capturing device 52, the adjustable focal point position 54 can be tuned to. P₀ can be defined at any position in an interior of the system 38. P₀ is predominantly determined by functional boundaries of the following features: a mechanism 56 of the system 38, adapted to automatically tune the adjustable focal point position 54, and by specifications of a lens system 58, adapted to capture images. Point P₁ marks a point where the adjustable focal point position 54 hits the reflective surface 50, or in other words where it hits a plain representing the reflective surface 50. P₂ lies in a distance D measured from P₁ to P₂ D is equal to a distance from the display 44 of the visual output device 42 to P₁. The distance from the display 44 of the visual output device 42 to P₁ can be chosen by the person skilled in the art according to technical specifications of the system 38, taking into account that a sufficiently large area 74 on the reflective surface 50 needs to be assessable by the system 38.

The adjustable focal point position 54 tuned to P₁ represents one capturing position 60 of the visual capturing device 52. The adjustable focal point position 54 tuned to P₂ represents a complementary capturing position 62.

Each one of the test images 64 displayed onto the reflective surface 50, according to step b) of the method of the invention, is mirrored as a reflection 68 in the direction of the visual capturing device 52. Only for reasons of clarity the arrows in FIG. 2A indicating the reflections 68 and the adjustable focal point position 54 are illustrated displaced from one another.

The visual capturing device 52 is adapted to tune the adjustable focal point position 54 to the one capturing position 60 and to capture at least one image 70 in the one capturing position 60. This represents steps c) and d) of the method of the invention. Further, the visual capturing device 52 is adapted to tune the adjustable focal point position 54 to the complementary capturing position 62 and to capture at least one complementary image 72 in the complementary capturing position 62. This represents step e) and f) of the method of the invention. The one image 70 and the complementary image 72 captured, show the area 74 of the reflective surface 50 and the reflection 68. This is accomplished for each one of the test images 64 reaching the visual capturing device 52 as a reflection 68. As an example, one image 70 and one complementary image 72 as captured in steps d) and f) of the method of the invention are illustrated in FIGS. 2B and 2C. The image 70 and complementary image 72 in each one of the FIGS. 2B and 2C correlate to the respective one test image 66. Here, the reflective surface 50 in step d) in FIG. 2C is also shown in greater detail than the reflective surface 50 in step d) in FIG. 2B.

The system 38 shown in FIG. 2A comprises a data processing unit 76 an evaluation algorithm 80. The evaluation algorithm 80 is adapted to derive objective quality parameters 88 of the reflective surface 50 from the one image 70, which are color 12, orange peel 24 and microwaviness 26 of the reflective surface 50. The evaluation algorithm 80 is further adapted to derive objective quality parameters 88 of the reflective surface 50 from the complementary image 72, which are color 12, specular gloss 32, haze 34 and clarity 36 of the reflection 68 of the at least one test image 66 reflected by the reflective surface. This represents step g) of the method of the invention. This step g) is illustrated in FIG. 2B. Just as an example, the evaluation algorithm 80 derives the orange peel 24 of the reflective surface 50 from the one image 70 and derives the clarity 36 of the reflection 68 of the test image 66 from the complementary image 72. The evaluation algorithm 80 quantifies characteristics of these objective quality parameters 88 on a scale from 0 to 10. In this example, the orange peel 24 is characterized by a value of 4 and the clarity 36 is characterized by a value of 3. Analogically, the evaluation algorithm 80 does so for the color 12, the microwaviness 26, the specular gloss 32 and the haze 34 as additional objective quality 88 parameters.

The data processing unit 76 of the system 38 shown in FIG. 2A comprises a database 78. The database 78 is equipped with data 82 representing correlation between visual appearance of reflective reference surfaces and the objective quality parameters 88. As shown in FIG. 2B, the characteristics of the objective quality parameters 88 from step g) of the method of the invention are compared with the data 82 by the evaluation algorithm 80 in step h) of the method of the invention. Just as an example, the characteristics of the objective quality parameters 88 are logically interlinked in step g) and the specific combination is matched with a corresponding visual appearance of a reflective reference surface in step h). In the given example, this leads to a value of 2 on a scale for the visual appearance included in the data 82. For example a value of 2 could represent an average visual appearance from a proficient customer's point of view. A value of 1 could represent a good visual appearance and a value of 3 could represent a bad visual appearance.

A result is then given out by the system, for example by a graphical user interface 86. The result could be that the reflective surface 50 features an average/normal visual appearance from a proficient customer's point of view.

FIG. 3 illustrates another preferred embodiment of a system for assessing the visual appearance of a reflective surface according to the invention. The system is based on the system 38 in FIG. 2A. Therefore, the same reference signs are applicable.

In this embodiment the system 38 is designed as a hand-held unit 40. The hand-held unit 40 comprises a case-like design. The hand-held unit 40 features all important aspects of the system 38 of the invention: the visual output device 42, comprising an internal display 44, the visual capturing device 52, which is an machine camera in this embodiment and the data processing unit 76. The data processing unit is an industrial micro computer in this embodiment and comprises the database 78, the evaluation algorithm 80 and a control algorithm 90. The control algorithm 90 is adapted to control all functionalities of the hand-held unit 40 which means functionalities of the system 38. The hand-held unit 40 comprises a graphical user interface 86 with an input and output function. Further, there is a measurement window 46.

Through the measurement window 46 light is able to enter or to leave an interior of the hand-held unit 40. The hand-held unit 40 comprises a contact section 48. The contact section 48 allows for positioning the hand-held unit 40, which means the system 38, on a reflective surface 50 as indicated in FIG. 2A. Preferably the hand-held unit 40 comprises means of wireless communication to allow for detection of workpieces featuring the reflective surface 50.

### LIST OF REFERENCE NUMBERS

10 visual appearance
12 color
14 gloss
16 focusing the surface of the item
18 waviness
20 longwave spectrum
22 shortwave spectrum
24 orange peel
26 microwaviness
28 focusing a reflection of the image
30 DOI
32 specular gloss
34 haze
36 clarity
38 system
40 hand-held unit
42 visual output device
44 display
46 measurement window
48 contact section
50 reflective surface
52 visual capturing device
54 adjustable focal point position
56 mechanism
58 lens system
60 one capturing position
62 complementary capturing position
64 test images
66 test image
68 reflection
70 one image
72 complementary image
74 area
76 data processing unit
78 database
80 evaluation algorithm
82 data
86 graphical user interface
88 objective quality parameters
90 control algorithm
D distance
P₀ point
P₁ point
P₂ point

1. System for assessing the visual appearance of a reflective surface, comprising at least:
a) a visual output device, adapted to display at least one test image onto the reflective surface;
b) a visual capturing device, comprising an adjustable focal point position;
wherein the adjustable focal point position is tunable to the reflective surface as one capturing position and to a complementary capturing position that allows for clear capturing of the test image as a reflection from the reflective surface; and
wherein the visual capturing device is adapted to capture at least one image in the one capturing position and to capture at least one complementary image in the complementary capturing position;
c) a data processing unit, comprising a database and an evaluation algorithm;
wherein the database is equipped with data representing correlation between visual appearance of reflective reference surfaces and objective quality parameters; and
wherein the evaluation algorithm is adapted to derive the objective quality parameters of the reflective surface from the one image and from the complementary image and to compare the objective quality parameters with the data of the database to assess visual appearance of the reflective surface.

2. System according to claim 1, wherein the data of the database ( ) comprise logical conjunction of:
statistically confirmed results of target group interrogation regarding visual appearance of reflective reference surfaces; and
objective quality parameters.

3. System according to claim 1, wherein the data processing unit comprises a control algorithm adapted to automatically control the steps of:
a) displaying the at least one test image;
b) tuning the adjustable focal point position to the one capturing position;
c) capturing at least one image in the one capturing position;
d) tuning the adjustable focal point position to the complementary capturing position;
e) capturing at least one complementary image in the complementary capturing position;
f) deriving objective quality parameters of the reflective surface from the one image and from the complementary image;
g) comparing the objective quality parameters with the data of the database to assess visual appearance of the reflective surface; and
h) outputting a result representative for visual appearance of the reflective surface.

4. System according to claim 3, wherein the control algorithm is adapted to:
repeat the steps a) to g) using different test images; and
combining results of all iterations of step g); and
outputting a result representative for visual appearance of the reflective surface.

5. System according to claim 1, comprising a contact section adapted to position the system on the reflective surface.

6. System according to claim 1, wherein the visual capturing device comprises a mechanism, adapted to automatically tune the adjustable focal point position.

7. System according to claim 1, wherein the visual capturing device is adapted to allow for capturing of the one image in the one capturing position and the complementary image in the complementary capturing position so that an area of the reflective surface covered by the one image and the complementary image measures 20 mm by 10 mm to 30 mm by 20 mm.

8. System according to one claim 1, wherein the visual capturing device is adapted to tune the adjustable focal point position with an accuracy of at least +/−0.3 mm.

9. System according to claim 1, wherein the adjustable focal point position is tunable in less than 500 ms.

10. System according to claim 1, wherein the visual capturing device comprises an image sensor comprising a pixel size of less than 50 μm.

11. System according to claim 1, wherein the system is a hand-held unit.

12. System according to claim 11, wherein dimensions of the system measure not more than 200 mm by 150 mm by 60 mm and/or a weight of the system measures not more than 1.5 kg and/or the system comprises an energy source.

13. System according to claim 1, wherein the system comprises at least one of the following elements:
a display as a feature of the visual output device;
a camera as a feature of the visual capturing device;
a microprocessor as a feature of the data processing unit;
a graphical user interface;
means of wireless communication.

14. Method of assessing the visual appearance of a reflective surface of a vehicle, wherein a system according to claim 1.

15. Method according to claim 14, comprising at least the step of:
a) positioning of a contact section of the system on the reflective surface of the vehicle;
b) displaying of at least one test image onto the reflective surface by a visual output device of the system;
c) tuning of an adjustable focal point position of a visual capturing device of the system to the reflective surface as one capturing position;
d) capturing of at least one image in the one capturing position by the visual capturing device;
e) tuning of the adjustable focal point position to a complementary capturing position that allows for clear capturing of the test image as a reflection from the reflective surface;
f) capturing of at least one complementary image in the complementary capturing position;
g) deriving of objective quality parameters of the reflective surface from the one image and from the complementary image by an evaluation algorithm of a data processing unit; and
h) comparing of the objective quality parameters with data of a database of the a data processing unit representing correlation between visual appearance of reflective reference surfaces and the objective quality parameters by the evaluation algorithm to assess visual appearance of the reflective surface.
